(19) United States
(12) Patent Application Publication
(10) Pub. No.: US 2018/0130023 A1
(43) Pub. Date: May 10, 2018

(54) VERIFYING JOB APPLICANT IDENTITY DURING A HUMAN RESOURCE JOB SCREENING PROCESS

(71) Applicant: International Business Machines Corporation, Armonk, NY (US)

(72) Inventors: Swathi Mantripragada, Toronto, ON (CA); Subha Kiran Patnaikuni, Visakhapatnam (IN); Saraswathi Sailaja Perumalla, Visakhapatnam (IN); Sri Harsha Varada, Vizianagaram (IN)

(21) Appl. No.: 15/344,030

(22) Filed: Nov. 4, 2016

(51) Int. Cl. G06Q 10/10; G06F 17/30

(52) U.S. Cl. CPC G06Q 10/1053; G06F 17/30743

(57) ABSTRACT

A method of verifying job applicant identity during a human resources job screening process includes capturing a first voice signature of a job applicant, storing the voice signature, capturing a second voice signature of the job applicant, comparing the second voice signature to the first voice signature, and providing one of a first output if the second voice signature matches the first voice signature and a second output if the second voice signature does not match the first voice signature.

### BACKGROUND

The present invention relates to the art of applicant screening systems and, more particularly, to a method of verifying job applicant identity during a human resources job screening process.

Human resource (HR) personnel are faced with a myriad of challenges during a hiring process. Locating qualified applicants is just one hurdle confronting HR personnel. HR personnel typically employ a multi-stage screening process when seeking qualified applicants for an open position. Often times, the screening process begins with a phone screen and is followed by one or more in-person interviews. Many HR managers are frustrated by applicants that present well during a phone screen only to fall short during the in-person interview process. It has been found that on occasion, the person being interviewed during the phone screen and the person appearing for the in-person interview are not the same people. Interviewing unqualified applicants represents a time waste for HR managers that can add costs to an overall hiring process

### SUMMARY

According to an aspect of an exemplary embodiment, a method of verifying job applicant identity during a human resources job screening process includes capturing a first voice signature of a job applicant, storing the voice signature, capturing a second voice signature of the job applicant, comparing the second voice signature to the first voice signature, and providing one of a first output if the second voice signature matches the first voice signature and a second output if the second voice signature does not match the first voice signature.

According to another aspect of an exemplary embodiment, a system for verifying job applicant identity during a human resources job screening process includes a central processor unit (CPU), a non-volatile memory operatively connected to the CPU, and audio signature comparison system having an audio signature comparison module. The audio signature comparison module includes computer readable program code embodied therewith. The computer readable program code, when executed by the CPU, causes the CPU to capture a first voice signature of a job applicant, store the voice signature, capture a second voice signature of the job applicant, compare the second voice signature to the first voice signature, and provide one of a first output if the second voice signature matches the first voice signature and a second output if the second voice signature does not match the first voice signature.

According to another aspect of an exemplary embodiment, a computer program product includes a computer useable medium including a computer readable program. The computer readable program, when executed on a computer, causes the computer to capture a first voice signature of a job applicant, store the voice signature, capture a second voice signature of the job applicant, compare the second voice signature to the first voice signature, and provide one of a first output if the second voice signature matches the first voice signature and a second output if the second voice signature does not match the first voice signature.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a flow chart illustrating a method of verifying job applicant identity during a human resources job screening process, in accordance with an aspect of an exemplary embodiment;

FIG. 2 depicts a block diagram representing an audio signature comparison system, in accordance with an aspect of an exemplary embodiment; and

FIG. 3 is a schematic block diagram of a general-purpose computer suitable for practicing the method of verifying job applicant identity during a human resources job screening process, in accordance with an aspect of an exemplary embodiment.

### DETAILED DESCRIPTION

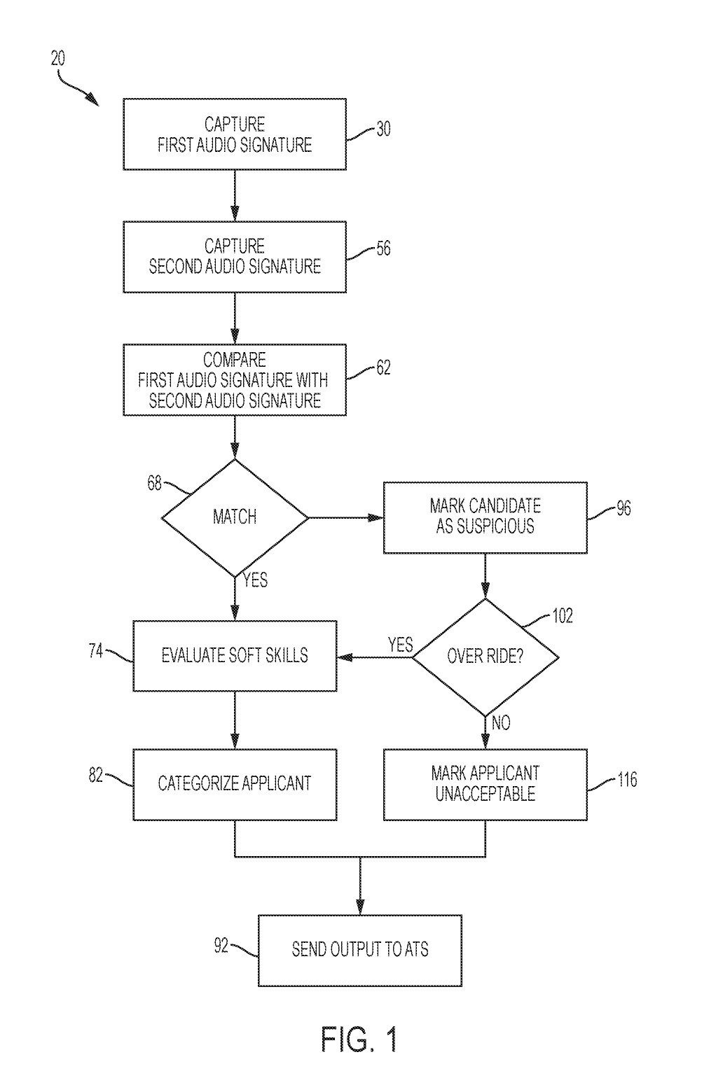

With reference now to FIG. 1, a method of verifying job applicant identity during a human resources job screening process is illustrated generally at 20. Human resources personnel invest considerable resources in locating, evaluating and training new hires. The resources may include financial resources invested in recruiters, advertisements and the like, and time invested in screening, interviewing and training each new hire. Imposter candidates waste both time and financial resources invested in filling an open position. It is to be understood that the term “imposter candidate” describes a job applicant that employs someone other than himself for a telephone screen in order to improperly gain access to a second layer of a new hire interview process.

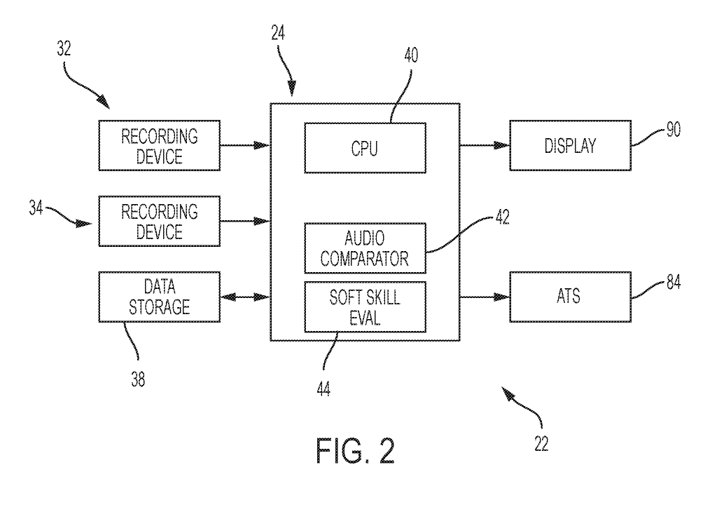

The exemplary embodiments provide a system that can substantially eliminate impostor candidates advancing to a third or subsequent tier in the new hire interview process. In accordance with an aspect of an exemplary embodiment, an interviewer may employ an audio signature comparison system 22 including an audio signature comparison module 24 to evaluate potential candidates as shown in FIG. 2. In accordance with an aspect of an exemplary embodiment, during an initial phone screen contact, a first audio or voice signature of an applicant is captured as indicated in block 30. The first voice signature may be captured through a recording device 32 that may form part of an audio device such as a phone system, a smart phone device, a general purpose computer or the like (not separately labeled).

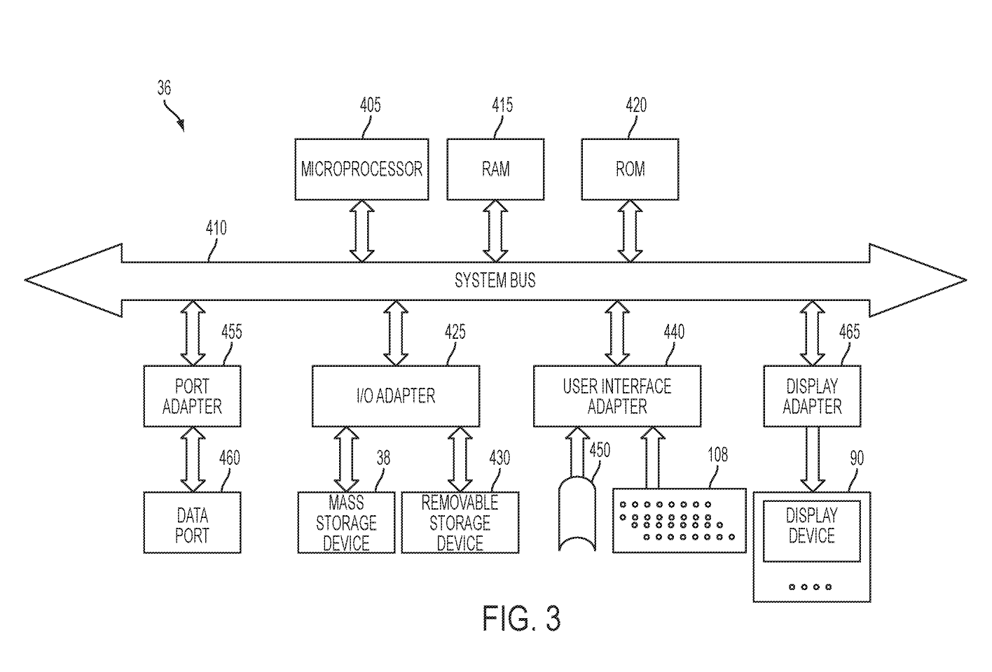

Alternatively, the recording device may take the form of a stand-alone recording system 34 that is capable of interfacing with a smart phone device or a general purpose computer such as shown at 36 in FIG. 3 through one or more known communication protocols. It is to be understood that the term “general purpose computer” describes various known computer types including mobile devices as well as less portable units. The first voice signature is stored and indexed for later evaluation. For example, the first voice signature may be stored in non-volatile memory such as a mass data storage device 38 of general purpose computer 36. The first and second voice signatures may then be sent to audio signature comparison module 24. Audio signature comparison system 24 may include a processor 40, an audio signature comparator 42 and a soft skill evaluation module 44.

If the applicant passes the first screening, in block 56, a second audio or voice signature is captured. The second voice signature, which may take the form of an in-person voice signature, may be captured during a second phone screen or during an in-person interview. It is to be understood that the second voice signature may be captured at a second round of interviews or at a subsequent point in time. It should also be understood that the exemplary embodiments can be employed across multiple rounds of interviews and is not limited to a first interview and a second interview. In a manner similar to that described above, the second audio or voice signature may be captured through a recording device 32 that may form part of an audio device such as a phone system, a smart phone device, a general purpose computer or the like. Alternatively, the second voice signature may be captured by recording device 34. The second voice signature is also stored and indexed in mass data storage device 38. It is to be understood that additional voice signatures may also be captured.

The first and second voice signatures are sent to an audio signature comparison module 24 to be evaluated by audio signature comparator 42. In block 62. A comparison is made between the first voice signature and the second voice signature. If additional voice signatures were captured, the comparison may be expanded to evaluate all or some of any additional captured voice signatures. Audio signature comparator 42 may employ a variety of processes to compare voice signatures including, for example, analytic comparison techniques and/or cognitive comparison techniques. In block 68, a determination is made whether the second voice signature matches the first voice signature.

If, in block 68, a match is indicated to exist, in block 74 if selected, soft skills may be evaluated by soft skill evaluation module 44. For example, soft skill evaluation module 44 may evaluate various speech related skills, such as tone, demeanor, grammar and the like, possessed by the applicant. The applicant may then be put into various skill categories, as noted in block 82, and stored in mass data storage device 38, transferred to an applicant tracking system 84, or results put on a display device 90 as indicated in block 92 for later evaluation and consideration for a desirable fit with a particular position.

In accordance with an aspect of an exemplary embodiment, audio analytic benchmarks may be established for certain roles in an organization. Soft skill evaluation module 44 may compare the voice signature against a benchmarks associated with a particular role considered for the applicant. In accordance with another aspect of an exemplary embodiment, soft skill evaluation module 44 may compare the captured voice signature against voice signatures captured from other members of the organization in similar roles. For example, soft skill evaluation module 44 may compare a voice signature from a candidate for a marketing position against other members of the organization, past or present, having a similar role. Further, as noted above, soft skill evaluation module 44 may identify audio patterns that may be employed to segregate candidates into different skill categories.

If, on the other hand, a match is not indicated to exist in block 68, an applicant may be marked as being suspicious in block 96. At this point, HR personnel have an option to override the comparison result in block 102. For example, an HR manager may have reason to believe that the comparison result is an error. Audio signature comparison module 24 may rely on cognitive learning processes to improve future comparisons if a comparison result is overridden. If an HR manager overrides the comparison result, the first and second voice signatures may be sent to soft skill evaluation module 44 in block 74. If the HR manager does not override the comparison result, the applicant is marked as unacceptable in block 116. At this point, the voice signatures and comparison result may be stored and archived.

The capabilities of the exemplary embodiments can be implemented in software, firmware, hardware, or some combination thereof. The method may be coded as a set of instructions on removable or hard media for use by the general purpose computer 36. FIG. 3 presents a block diagram of general purpose computer 36 suitable for practicing the embodiments of the present invention. In FIG. 3, general purpose computer 36 has at least one microprocessor or central processing unit (CPU) 405. CPU 405 is interconnected via a system bus 410 to a random access memory (RAM) 415, a read-only memory (ROM) 420, an input/output (I/O) adapter 425 for connecting a removable data and/or program storage device 430 and mass data and/or program storage device 38, a user interface adapter 440 for connecting a keyboard 108 and a mouse 450, a port adapter 455 for connecting a data port 460 and a display adapter 465 for connecting a display device 90.

ROM 420 contains the basic operating system for general purpose computer 36. The operating system may alternatively reside in RAM 415 or elsewhere, as is known in the art. Examples of removable data and/or program storage device 430 include magnetic media such as floppy drives and tape drives, and optical media such as CD ROM drives. Examples of mass data and/or program storage device 38 include hard disk drives and non-volatile memory such as flash memory. In addition to keyboard 108 and mouse 450, other user input devices such as trackballs, writing tablets, pressure pads, microphones, light pens, and position-sensing screen displays may be connected to user adapter 440. Examples of display devices include cathode-ray tubes (CRT) and liquid crystal displays (LCD).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment of the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of verifying job applicant identity during a human resources job screening process comprising:
capturing a first voice signature of a job applicant;
storing the first voice signature;
capturing a second voice signature of the job applicant;
comparing the second voice signature to the first voice signature; and
providing one of a first output if the second voice signature matches the first voice signature and a second output if the second voice signature does not match the first voice signature.

2. The method of claim 1, wherein capturing the first voice signature includes capturing a voice signature transmitted through an audio device.

3. The method of claim 2, wherein capturing the voice signature transmitted through the audio device includes capturing a voice signature received at a telephone.

4. The method of claim 1, wherein capturing the second voice signature includes capturing an in-person voice signature from the job applicant.

5. The method of claim 1, further comprising: evaluating soft skills of the job applicant from one of the first voice signature and the second voice signature when the first output is provided.

6. The method of claim 5, further comprising: categorizing the job applicant based on the soft skills.

7. A system for verifying job applicant identity during a human resources job screening process comprising:
a central processor unit (CPU);
a non-volatile memory operatively connected to the CPU; and
an audio signature comparison system having an audio signature comparison module, the audio signature comparison module including computer readable program code embodied therewith, the computer readable program code, when executed by the CPU, causes the CPU to:
capture a first voice signature of a job applicant;
store the first voice signature;
capture a second voice signature of the job applicant;
compare the second voice signature to the first voice signature; and
provide one of a first output if the second voice signature matches the first voice signature and a second output if the second voice signature does not match the first voice signature.

8. The system of claim 7, wherein the computer readable program code, when executed by the CPU, causes the CPU to: capture a voice signature transmitted through an audio device when capturing the first voice signature.

9. The system of claim 8, wherein the computer readable program code, when executed by the CPU, causes the CPU to: capture a voice signature received at a telephone when capturing the voice signature transmitted through the audio device.

10. The system of claim 7, wherein the computer readable program code, when executed by the CPU, causes the CPU to: capture an in-person voice signature from the job applicant when capturing the second voice signature.

11. The system of claim 7, wherein the computer readable program code, when executed by the CPU, causes the CPU to: evaluate soft skills of the job applicant from one of the first voice signature and the second voice signature when the first output is provided.

12. The system of claim 11, wherein the computer readable program code, when executed by the CPU, causes the CPU to: categorize the job applicant based on the soft skills.

13. The system of claim 11, wherein the computer readable program code, when executed by the CPU, causes the CPU to: send one of the first output and the second output to an applicant tracking system.

14. A computer program product comprising:
a computer useable medium including a computer readable program, wherein the computer readable program, when executed on a computer, causes the computer to:
capture a first voice signature of a job applicant;
store the first voice signature;
capture a second voice signature of the job applicant;
compare the second voice signature to the first voice signature; and
provide one of a first output if the second voice signature matches the first voice signature and a second output if the second voice signature does not match the first voice signature.

15. The computer program product of claim 14, wherein the computer readable program, when executed on a computer, causes the computer to: capture a voice signature transmitted through an audio device when capturing the first voice signature.

16. The computer program product of claim 15, wherein the computer readable program, when executed on a computer, causes the computer to: capture a voice signature received at a telephone when capturing the voice signature transmitted through the audio device.

17. The computer program product of claim 14, wherein the computer readable program, when executed on a computer, causes the computer to: capture an in-person voice signature from the job applicant when capturing the second voice signature.

18. The computer program product of claim 14, wherein the computer readable program, when executed on a computer, causes the computer to: evaluate soft skills of the job applicant from one of the first voice signature and the second voice signature when the first output is provided.

19. The computer program product of claim 18, wherein the computer readable program, when executed on a computer, causes the computer to: categorize the job applicant based on the soft skills.

20. The computer program product of claim 18, wherein the computer readable program, when executed on a computer, causes the computer to: send one of the first output and the second output to an applicant tracking system.
